(19) United States
(12) Patent Application Publication
(10) Pub. No.: US 2011/0294108 A1
(43) Pub. Date: Dec. 1, 2011

(54) System and Method for an Ex Vivo Body Organ Electrosurgical Research Device

(75) Inventors: Gayle L. Argoudelis, Erie, CO (US); Tom E. McMunigal, Mead, CO (US); Anthony B. Ross, Boulder, CO (US)

(73) Assignee: TYCO Healthcare Group LP

(21) Appl. No.: 12/789,812

(22) Filed: May 28, 2010

(51) Int. Cl. A01N 1/02

(52) U.S. Cl. 435/1.2; 435/284.1

(57) ABSTRACT

The present disclosure is directed to a system and method for inflating and perfusing a body organ. The system and method includes a housing, a vacuum source, a perfusion pump and a temperature control module. The housing defines a cavity for containing an ex vivo body organ. In embodiments, the housing may include a cover. The housing includes one or more apertures that are defined therethrough and configured to mechanically interface with one or more sensors. The vacuum source is configured to inflate and deflate the body organ. The perfusion pump is configured to circulate a solution into the body organ. The temperature control module is operatively connected to one or more heating elements and one or more cooling elements. In addition, the temperature control module is configured to regulate the temperature of the body organ within the housing.

### BACKGROUND

1. Technical Field

The present disclosure relates to a system for maintaining an ex vivo body organ during electrosurgical procedures. More particularly, the present disclosure relates to a system for simulating respiration and circulation of an ex vivo body organ during electrosurgical procedures.

2. Description of Related Art

Studies have shown that lung cancer is the number one cause of cancer related deaths in the world. Additionally, statistics report five year survival rates as low as 15% for lung cancer patients that have lung cancer in an advanced state. Currently, surgery that requires removal of cancerous lung tissue is the most preferred treatment of lung cancers. However, a majority of patients are not candidates for surgical removal of lung tissue due to age, poor lung function, and/or heart conditions. As an alternative treatment, thermal ablation is a minimally invasive treatment option for lung cancer patients and has been shown to be effective for tumors less than 3 cm.

It is a common practice for most experimentation of electrosurgical devices (e.g., thermal ablation devices) to be performed on lung cancer with in vivo models or human trials. Performing in vivo experiments for medical devices is expensive, requires long lead times for protocol approval, can be difficult to achieve adequate sample sizes, and should be limited when possible for ethical considerations.

### SUMMARY

The present disclosure is directed to a system for inflating and perfusing a body organ. The system includes a housing, a vacuum source, a perfusion pump and a temperature control module. The housing defines a cavity for containing an ex vivo body organ. In embodiments, the housing may include a cover. The housing includes one or more apertures that are defined therethrough and configured to mechanically interface with one or more sensors. The vacuum source is configured to inflate and deflate the body organ. The perfusion pump is configured to circulate a solution into the body organ. The temperature control module or device is operatively connected to one or more heating elements and one or more cooling elements. In addition, the temperature control module is configured to regulate the temperature of the body organ within the housing.

The system further includes a logistic system that is operably connected to the temperature control module, the perfusion pump, the vacuum source and/or the one or more sensors. Additionally, the logistic system is configured to regulate the pressure, flow rate and/or temperature of the body organ during electrical treatment of the body organ. The logistic system may include a computer for analyzing data received from the one or more sensors, the temperature control module, the perfusion pump, and/or the vacuum source.

In other embodiments, the system may include a conductive ground plate that is disposed within the housing and is configured to provide a return path during radio frequency electrical treatment of the body organ.

In another aspect of the present disclosure, a method for inflating and perfusing a body organ is provided. One step includes flushing blood from the body organ. In another step, the body organ is placed into a housing. In other step, a perfusion solution (e.g., saline solution) is pumped from a perfusion pump and introduces the perfusion solution under a predetermined pressure into the body organ through a natural orifice. In another step, temperature of the perfusion solution is regulated within the body organ. In another step, the body organ is inflated with a vacuum source to a predetermined pressure contained within the housing. In another step, an electrosurgical treatment is performed to the body organ within the housing.

In other embodiments, a further step may include acquiring data relating the electrosurgical treatment of the body organ. The data may relate to a pressure and a temperature of the body organ during electrosurgical treatment.

### BRIEF DESCRIPTION OF THE DRAWINGS

Various embodiments of the subject instrument are described herein with reference to the drawings wherein:

FIG. 1 is an enlarged, perspective model view of an ex vivo body organ tank system according to one embodiment of the present disclosure;

FIG. 2 is an enlarged, exploded view of the ex viva body organ tank system of FIG. 1;

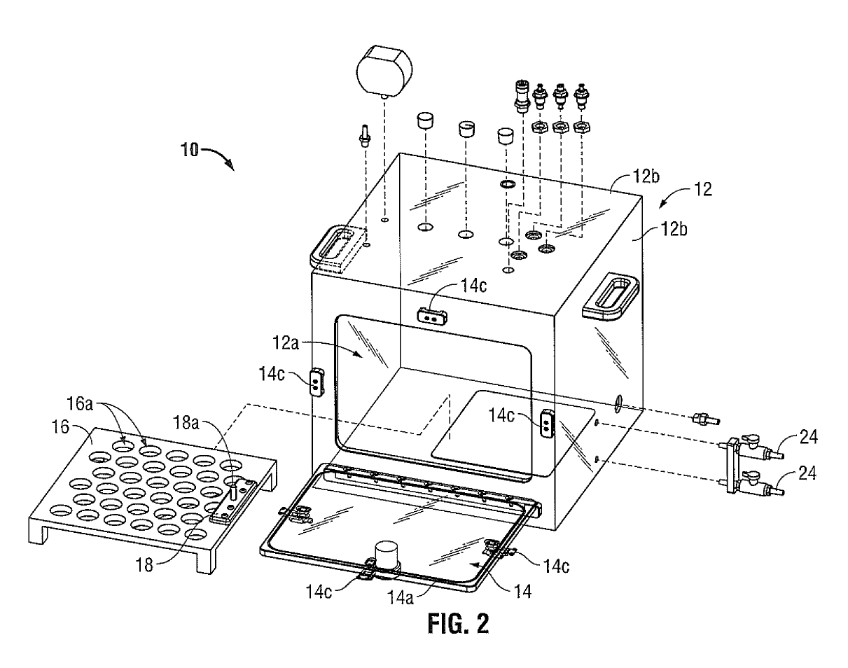

FIG. 3 is a schematic representation of the ex vivo body organ tank system of FIG. 1; and

FIG. 4 is a schematic representation of an ex vivo body organ tank system according to another embodiment of the present disclosure.

### DETAILED DESCRIPTION

In accordance with the present disclosure, it has been determined in the medical research field that ex vivo experiments, in contrast to in vivo experiments, can be performed rapidly and ethically, with a much reduced cost. For example, lung cancers (i.e., lung tumors) are often very different than the parenchymal lung tissue in terms of density, electrical properties, and stiffness. The lung is also highly vascular and is continually inhaling and expelling air; all of which affect electrosurgical performance. In the treatment of diseases such as cancer, certain types of cancer cells have been found to denature at elevated temperatures that are slightly lower than temperatures normally injurious to healthy cells. Known treatment methods, such as hyperthermia therapy, use electrosurgical energy (e.g., electromagnetic radiation) to heat diseased cells to temperatures above 41° C. while maintaining adjacent healthy cells below the temperature at which irreversible cell destruction occurs. These methods involve applying electrosurgical energy to heat, ablate and/or coagulate tissue. Radiofrequency (RF) or microwave energy is often utilized to perform these procedures. Accordingly, these methods can also be applied to other types of body organs, for example, a liver and a stomach.

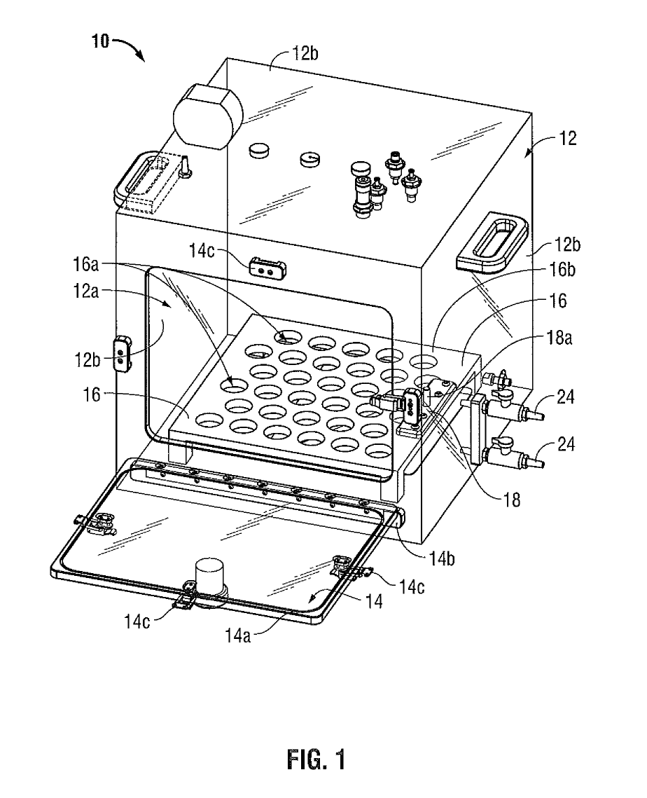

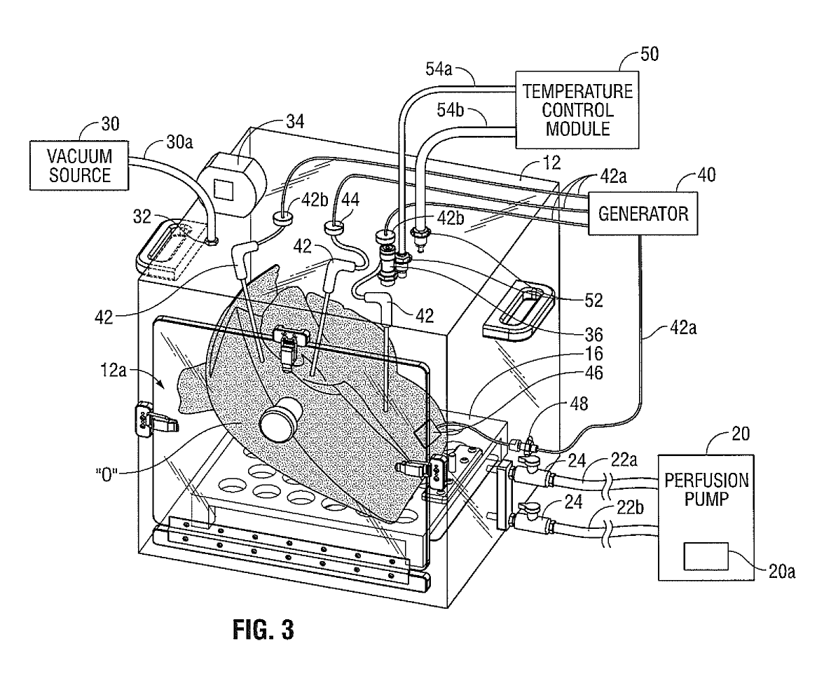

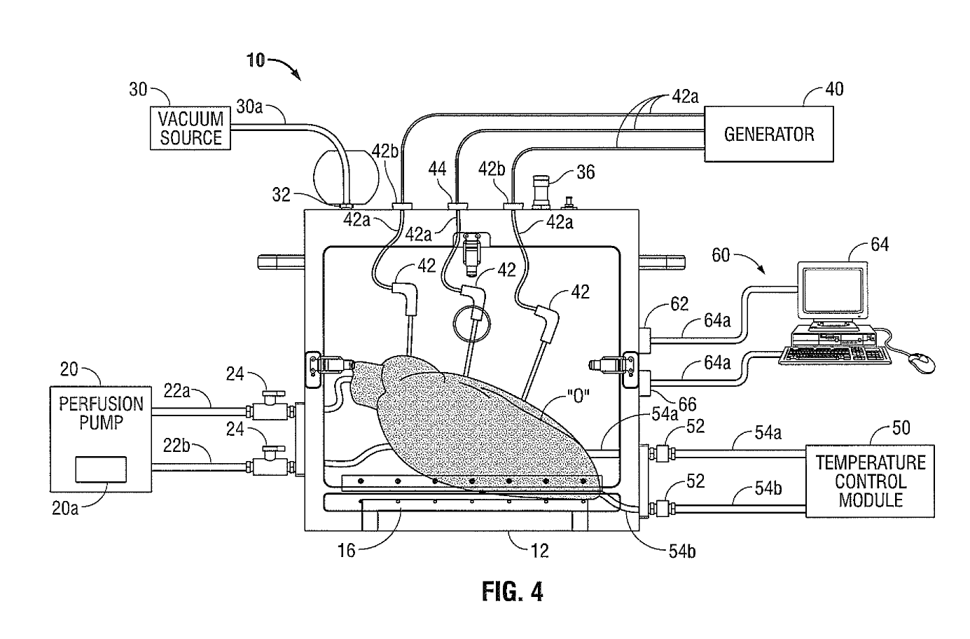

Referring initially to FIG. 1, electrosurgical research tank system 10 includes a housing 12 having a plurality of panels 12b (e.g., sides) that are configured in a box-like configuration. Tank system 10 is configured to allow for a highly repeatable and highly controllable testing environment for modeling heat loss within body organ “O” during the application of electrical energy, such as microwave ablation or radiofrequency application. Panels 12b may be made of transparent plexiglass, polycarbonate, or any other suitable housing material. Tank system 10 also includes a plurality of fittings and sensors positioned on housing 12 to allow logical connection and interaction with various external devices. Housing 12 defines an interior cavity 12a that is configured to contain a body organ “O,” for example, a lung (as shown in FIGS. 3 and 4). As discussed above, other body organs “O” may be utilized with tank system 10, for example, but not limited to a heart and a liver.

Housing 12 may include a cover or door 14 that is configured to have an open or closed configuration, such that in the closed configuration housing 12 is hermetically sealed. Cover 14 may include a gasket 14a or any other suitable sealing structure to facilitate sealing of inner cavity 12a from an external environment. It is envisioned that gasket 14a may either be mounted on housing 12 or on cover 14. Cover 14 may also be hingedly connected to housing 12 by a hinge 14b to allow cover 14 to have the open and closed configurations. Hinge 14b may be any type of suitable hinging device, for example, but not limited to a pivot hinge, a living hinge, a continuous hinge, a strap hinge or a floating hinge. In addition, cover 14 may be secured in the closed configuration by one or more latches 14c or any other suitable latching and/or locking structures.

Body organ “O” may be placed on a lower plate 16 within inner cavity 12a, instead of direct placement on inner cavity 12a. Lower plate 16 provides a raised surface within inner cavity 12a such that any fluids released from body organ “O” may drip downwardly through apertures 16a of lower plate 16 and away from body organ “O.” In addition, lower plate 16 may comprise a heating element 16b to maintain body organ “O” at a suitable ambient temperature (e.g. body temperature) in order to imitate an internal body environment, if necessary.

In other embodiments, a mounting bracket 18 may be disposed within inner cavity 12a. Mounting bracket 18 may include a support arm 18a or any other suitable supporting structure that may include, for example, remotely controlled robotic arms. The various support structures and other components of tank system 10 may all be selectively removable to facilitate cleaning and/or replacement of accessories.

Turning now to FIG. 3, tank system 10 further includes a perfusion pump 20 that draws a perfusion solution (e.g., a saline solution) from a reservoir 20a for circulation purposes of body organ “O.” Perfusion pump 20 is connected to body organ “O” via various perfusion lines and fittings such that the perfusion solution is drawn from the reservoir 20a via pump 20, which forces the solution into body organ “O” through one or more vessel entry points (e.g., pulmonary vein and artery) in the body organ “O.” More particularly, inlet line 22a and outlet line 22b fluidly connect perfusion pump 20 with body organ “O” via valves and/or fittings 24 that are mounted on housing 12. As one would appreciate in the art, other suitable connectors may be used to connect perfusion pump 20 with body organ “O”. In this configuration, perfusion pump 20 is configured to circulate a perfusion solution through body organ “O” in order to reduce edema and other negative effects. Alternatively, any other suitable type of fluid may be used to circulate the perfusion solution within the vasculature of body organ “O” (e.g., to mimic oxygenated blood flow).

In order to simulate blood flow in perfusion pump 20 under real conditions, inlet line 22a and outlet line 22b of perfusion pump 20 is adapted to accommodate the diameter size of the blood vessels of body organ “O.” For example, different tubing diameters and the multi-channel or multi-port perfusion pump 20 establish adjustable flow rates to simulate a heart of an animal, similar to a live animal (e.g., human or porcine). For example, a catheter made of Tygon™ tubing having a diameter of 5/16 of an inch may be inserted into the pulmonary artery to facilitate perfusion of a room temperature saline solution through the vasculature of a lung.

FIG. 3 also illustrates a vacuum source 30 that is operatively connected to tank system 10. More particularly, vacuum source 30 is connected to housing 12 via a vacuum valve 32 or any other suitable fittings. One or more vacuum valves 30 are securely and sealingly attached to housing 12 such that a suitable vacuum hose or line 30a may be connected to valve 32. Vacuum source 30 is configured to create a vacuum to reduce the pressure of inner cavity 12a and thus inflate body organ “O” to a predetermined volume. For example, the vacuum source 30 mimics the pressure relating to the inflation of a lung when an animal or a human breathes.

In other embodiments, tank system 10 may include various valves, gauges and fittings coupled to housing 12. More particularly, pressure gauge 34 or any other type of gauge or sensor is positioned about housing 12 and configured to indicate to a clinician on whether the pressure of the inner cavity 12a is above or below a predetermined condition. Additionally or alternatively, other types of sensors and gauges may be utilized and positioned about tank system 10, for example, but not limited to a temperature gauge, a barometric pressure gauge, and an oxygen level gauge.

In other embodiments, tank system 10 may include an air pressure relief valve 36 that is coupled to housing 12 to relieve any undesired air pressure within inner cavity 12a. In this manner, air pressure relief valve 36 prevents housing 12 from bulging outwards or exploding if undesired and excessive air pressure builds up.

During use, various electrosurgical instruments 42 may be used and disposed within tank system 10. Electrosurgical instruments 42 are logically connected to a generator 40 via cable or wires 42a. Cables 42a are inserted into housing 12 via surgical instrument inlets and/or slits 44.

When monopolar experimentation is necessary, a return electrode pad 46 may be utilized and disposed within inner cavity 12a of housing 12 for placement on body organ “O.” To facilitate attachment of return electrode pad 46 within inner cavity 12a, a ground receptacle 48 may be disposed alongside the housing 12, such that return electrode pad 46 may be connected thereto. Alternatively, lower plate 16 may be selectively configured to act as a conductive ground plate instead of utilizing return electrode pad 46. In this manner, a ground return is established when body organ “O” is placed atop lower plate 16 during monopolar electrosurgical procedures.

Housing 12 also includes a plurality of ports 42b that are configured to allow surgical instruments to be placed therethrough and within inner cavity 12 while cover 14 is in the closed configuration. Ports 42b may include zero closure valves or any other suitable valves to facilitate maintaining a constant air pressure within inner cavity 12 during the absence of an instrument.

Referring now to FIG. 4, in another example embodiment tank system 10 further includes a temperature control module 50 that is configured to selectively increase or decrease the temperature of body organ “O” when disposed within inner cavity 12a via a pump. Temperature control module 50 may be connected to body organ “O” and/or inner cavity 12a by various types of hoses and fittings. For example, luer-type fittings 52 may be used to connect temperature control module 50 to body organ “O” and/or inner cavity 12a. Any type of suitable fluid may be used with temperature control pump 50, for example, but not limited to water or a saline solution. Temperature control lines 54a and 54b are utilized to transport the temperature controlled medium between body organ “O” and temperature control pump 50.

In other embodiments, tank system 10 may include a logistic system 60 that has one or more sensors or transducers 62 that are configured to monitor the pressure, flow rate and/or temperature in the body organ “O” via wires 64a. A computer and/or a data acquisition system 64 is adapted to monitor, record and/or regulate the various operating and control elements (via the measured values) of tank system 10 (e.g., perfusion pump 20, vacuum source 30, generator 40, temperature control module 50, and logistic system 60) via wires 64a. This enables an operator to vary certain parameters of tank system 10 to simulate various conditions. Valves 66 may also be regulated to control the flow of fluid into the system (e.g., perfusion pump 20). The control conditions are highly controllable and highly repeatable with limited variability in the testing environment. This enables an operator to test body organ “O” tissue reaction (e.g., lung tissue) under consistent operating conditions with minimal variation amongst the pre-set operating parameters. The system 10 also enables the operator to vary certain parameters, e.g., temperature, pressure, etc., while maintaining other parameters fixed for experimental purposes.

In use, tank system 10 may be utilized to regulate, monitor and/or adjust the pressure, flow rate and/or temperature of one or more of the components logically coupled to body organ “O,” including, but not limited to perfusion pump 20, vacuum source 30, generator 40, temperature control module 50 and logistic system 60.

The present disclosure also relates to a method for maintaining a body organ “O” for repeatable experimentation (e.g., a lung) and includes the step of flushing blood from body organ “O” utilizing one or more suitable flushing procedures that utilizes a saline flushing solution or a saline. The method also includes the steps of: placing the body organ “O” into a housing 12; performing a perfusion with a solution via perfusion pump 20 into the body organ “O” through an orifice (e.g., pulmonary vein or artery); regulating the ambient pressure with vacuum source 30 (e.g., typically 0.7-1 in Hg to inflate the lung); and performing one or more electrosurgical treatments with generator 40 and one or more electrosurgical instruments 42.

The method may further include regulating the temperature of the solution of perfusion pump 20 with temperature control pump 50 and sensors 62 that are regulated and monitored with a logistic system 60; and acquiring data relating to the pressure, flow rate and temperature of the solution during electrical treatment of the body organ “O” with logistic system 60.

As shown in FIGS. 3 and 4, during electrosurgical experimental treatment one or more electrosurgical devices (e.g., ablation probes 42) treat tissue or organs “O” (e.g., lung) containing cancerous tumors. Once the probes 42 are positioned within organ “O,” electrosurgical energy is passed therethrough to treat surrounding tissue.

Energy is typically applied via ablation probes 42 that penetrate tissue. For example, and with particular respect to microwave energy probes, several types of antenna assemblies are known, such as monopole and dipole antenna assemblies. In monopole and dipole antenna assemblies, microwave energy generally radiates perpendicularly away from the axis of the conductor. A monopole antenna assembly includes a single, elongated conductor that transmits microwave energy. A typical dipole antenna assembly has two elongated conductors, which are linearly aligned and positioned end-to-end relative to one another with an electrical insulator placed therebetween. Each conductor may be about ¼ of the length of a wavelength of the microwave energy, making the aggregate length of the two conductors about ½ of the wavelength of the supplied microwave energy. During certain procedures, it can be difficult to assess the extent to which the microwave energy will radiate into and heat the surrounding tissue, making it difficult to determine the area or volume of surrounding tissue that will be ablated. In addition, in certain instances it may also be difficult to assess the extent to which heat is lost inside the tissue or organ during the ablation procedure.

In experiments, a tank system 10 was used and configured to enable experimentation on one or more organs “O” (e.g., porcine lung) using electrosurgical devices, for example, but not limited to radio frequency (RF) electrodes and microwave (MW) antennas. For example, the design of housing 12 allows for use of an endotracheal tube and simulates the mechanics of inspiration and respiration.

During the experiment, simulated tumors can be placed inside body organ “O” (e.g., lung tissue) such that an ablation may be performed. When body organ “O” is treated within tank system 10 by various electrosurgical techniques, the electrodes and/or microwave antennas produce results that closely match in vivo results.

An advantage offered by tank system 10 is that research is not limited to lung research and the particular organ may be respectively used without the expense of a whole animal and the use of veterinary surgical center. In addition, there is an ethical animal welfare benefit to this system as well. The lungs that are normally discarded after an animal is slaughtered for human consumption can be utilized for research purposes which, in turn, can reduce the need for clinical animal studies. Variables relating to inflation and perfusion can be easily manipulated when using the tank.

For example, during use, a fresh porcine pluck (i.e., a lung with an attached heart) may be obtained from a local slaughterhouse. Experiments have shown that porcine plucks should be used within 8 hours after harvest, since lung tissue becomes degraded more than 8 hours after harvest. In addition, subsequent perfusion of lungs harvested after 8 hours may result in edema. After the heart is removed, a tracheal tube may be introduced into the trachea. Afterwards, a catheter made of Tygon™ having a diameter of 5/16 of an inch may be inserted into the pulmonary artery to facilitate perfusion of room temperature saline throughout the vasculature. During experimentation, simulated tumors or tumor may be used and inserted into the caudal lobe(s) of a lung.

In experiments, it was shown that the size of an ablation appears to be proportional to the size of a tumor. In addition, an inflated lung model provided a substantially ideal environment for testing ablation devices. Some experiments revealed that approximately 1 in Hg inflated the ex vivo lung if a tracheal tube was allowed to communicate with ambient air. Without the tracheal tube vacuum pressures of up to 10 in Hg were required to inflate the lung. At these pressures the wall of the tank visibly bowed. High vacuum pressures also restricted the perfusion loop by collapsing the perfusion tubing to the pump.

In further experiments, a perfusion rate of 208 ml/min (pump setting of 1) was less than physiologic, but was used because it resulted in less edema while still providing adequate flow. The temperature of the saline solution also affected edema of the sample lung. At physiologic temperatures (37° C.) water tended to degrade the lung quickly and resulted in edema. Cold water (5° C.) preserved the lung longer. One concern with the cold perfusion was that it may inappropriately change heat transfer characteristics resulting in smaller ablations. Room temperature saline solution appeared to be an adequate balance between tissue preservation and heat transfer characteristics. Room temperature saline solution also did not require extra cooling or heating which simplified the experimental setup.

A variety of simulated tumors may be used with body organ “O,” for example, but not limited to an adjacent porcine heart tissue, a chunk of ex vivo bovine liver tissue, ground ex vivo liver tissue, and a tissue phantom (e.g., TX151). For the porcine heart tissue and bovine liver tissue, a 13 cm diameter sphere was excised from the tissue and sutured into the lung at a depth of 12 cm. When the lung was sutured reasonably well after the tumor had been inserted, it inflated such that little, if any, saline leaked out the suture site.

In experiments, the ground ex vivo liver tissue and tissue phantom (e.g., TX151) were injected using large gauge needles. This testing was limited to two attempts and complicated by the difficulty in pushing the ground liver through a 16 g needle. Typically, both the tissue phantom and ground liver injections formed ellipsoidal shapes. One advantage of the ex vivo tissue simulated tumors over the tissue phantom (e.g., TX151) for ablation studies is that the tissue responds to thermal doses similarly to tumors. There is visible coagulation at temperatures above around 55° C. and charring at higher temperatures. The tissue phantom tended to become more liquid at higher temperatures, but there was no definite visible thermal boundary that could be used to determine ablation size/completeness. An advantage of the heart tissue as a simulated tumor is that it is part of the pluck delivered with the lung.

In general, tank system 10 allows for convenient and reliable testing of ablation instruments. System 10 employs negative pressure to inflate porcine lungs and allows for continuous perfusion, simulating blood flow. Measured ablations sizes for both RF and MW correlate with simulated tumor size and qualitatively match well with in vivo experiments. Measured dielectric values are within reported ranges from literature.

From the foregoing and with reference to the various figure drawings, those skilled in the art will appreciate that certain modifications can also be made to the present disclosure without departing from the scope of the present disclosure. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed:

1. A system for inflating and perfusing a body organ, the system comprising:
a housing defining a cavity for containing an ex vivo body organ, the housing including a plurality of apertures defined therethrough configured to mechanically interface with at least one sensor;
a vacuum source configured to inflate and deflate the body organ;
a perfusion pump configured to circulate a solution into the body organ; and
a temperature control module operatively connected to at least one heating element and at least one cooling element, the temperature control module configured to regulate the temperature of the body organ within the housing.

2. A system for inflating and perfusing a body organ according to claim 1, wherein the housing further includes a cover.

3. A system for inflating and perfusing a body organ according to claim 1, further comprising a logistic system operably connected to the temperature control module, the perfusion pump, the vacuum source and the at least one sensor, the logistic system configured to regulate the pressure, flow rate and temperature of the body organ during electrical treatment of the body organ.

4. A system for inflating and perfusing a body organ according to claim 3, wherein the logistic system includes a computer for analyzing data received from the at least one sensor, the temperature control module, the perfusion pump, and the vacuum source.

5. A system for inflating and perfusing a body organ according to claim 1, further comprising a conductive ground plate disposed in the housing, the conductive ground plate configured to provide a return path during radio frequency electrical treatment of the body organ.

6. A system for inflating and perfusing a body organ according to claim 1, further comprising a specimen table including a plurality of apertures configured to allow fluid from the body organ to drip therethrough.

7. A system for inflating and perfusing a body organ according to claim 1, wherein the body organ is a lung and the perfusion pump circulates a perfusion solution therethrough in order to reduce edema and other negative effects.

8. A system for inflating and perfusing a body organ according to claim 1, wherein the perfusion solution includes saline.

9. A system for inflating and perfusing a body organ according to claim 1, further comprising an electrode holder for supporting at least one electrode during electrical activation thereof.

10. A method for inflating and perfusing a body organ comprising the steps of:
flushing blood from a body organ;
placing the body organ into a housing;
pumping a perfusion solution from a perfusion pump and introducing the perfusion solution under a predetermined pressure into the body organ through a natural orifice;
regulating the temperature of the perfusion solution within the body organ;
inflating the body organ with a vacuum source to a predetermined pressure contained within the housing; and
performing an electrosurgical treatment to the body organ within the housing.

11. A method according to claim 10, further comprising the step of acquiring data relating the electrosurgical treatment of the body organ.

12. A method according to claim 11, wherein the data relates to a pressure and a temperature of the body organ during electrosurgical treatment.

13. A method according to claim 10, wherein the perfusion solution includes saline.
